(19) United States
(12) Patent Application Publication
(10) Pub. No.: US 2008/0147530 A1
(43) Pub. Date: Jun. 19, 2008

(54) PROGRAMMATICALLY TRANSFERRING APPLICATIONS BETWEEN HANDSETS BASED ON LICENSE INFORMATION

(76) Inventors: Shu-Leung KWAN, Pleasanton, CA (US); Prem J. KUMAR, San Diego, CA (US); Hao CAI, San Jose, CA (US); Ravi HALKER, San Diego, CA (US)

Correspondence Address: QUALCOMM INCORPORATED, 5775 MOREHOUSE DR., SAN DIEGO, CA, 92121, US

(21) Appl. No.: 11/959,082

(22) Filed: Dec. 18, 2007

Related U.S. Application Data
(60) Provisional application No. 60/870,706, filed on Dec. 19, 2006.

(51) Int. Cl. H04K 1/00; G06Q 10/00; G06Q 30/00; H04L 9/00

(52) U.S. Cl. 705/34; 705/59; 705/1; 705/80; 705/26

(57) ABSTRACT

Transfer management of licensed applications from an original user equipment (UE) device to a destination UE device is facilitated by a communication network that tracks the inventory of software application that has been previously licensed, and suggests a suite of applications equivalent to, an upgraded version of, or an appropriate cross sell opportunity for a configuration (e.g., chipset and operating system) of a destination UE device (e.g., cellular telephone able to run applications such as games, media players, and personal organizers, etc.) Business rules automate pricing appropriate for the proposed configuration to automate and increase the convenience for both the user and provider. Once accepted, the appropriate executable code is distributed to the destination UE device, appropriate pro-rated billing is initiated, and the prior licensed applications either locked for subsequent transfer back, or deleted to effect a permanent transfer.

### CLAIM OF PRIORITY UNDER 35 U.S.C. §119

The present Application for patent claims priority to Provisional Application No. 60/870,706 entitled “METHODS, SYSTEMS, AND APPARATUS FOR CONTENT TRANSFER” filed 19 Dec. 2006, and assigned to the assignee hereof and hereby expressly incorporated by reference herein.

### BACKGROUND

Present aspects relate generally to communication, and more particularly to data communication networks that provision user equipment with application executable code.

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. With advances in computing technology, consumers are increasingly offered many types of electronic devices (“user equipment”) that can be provisioned with an array of software applications. Distinct features such as email, Internet browsing, game playing, address book, calendar, media players, electronic book viewing, voice communication, directory services, etc., increasingly are selectable applications that can be loaded on a multi-function device such as a smart phone, portable game console, or hand-held computer. Convenient purchase of desired applications is often available bundled upon initial purchase or subsequent to purchase of the hardware. Such separate software enabled features tend to be individually licensed, especially when purchased and downloaded separately from the hardware. As such, a particular user equipment (UE) can have significant residual value represented by such licenses, as well as subjective value given the time and inconvenience that would be required to similarly configure a replacement device.

With increases in technology, enhanced portability, and decreases in costs of many such software-enabled UE, the likelihood increases that the UE will be replaced frequently. First, an improved device can become available that a user prefers to use permanently, discarding or trading in a prior UE. Second, a UE that is quite small and portable can be lost or damaged while being carried. Third, a user may have an assortment of UE devices that are selected for a particular outing based on size, features, ruggedness, and aesthetics in a manner analogous to choosing a watch or purse. However, purchasing additional licenses for these scenarios is unnecessary in that the user will only be using one device at a time. In order to encourage the initial purchase and to maintain customer loyalty, vendors of software applications may desire to use licenses that would provide a no-cost transfer to another device; however, the economic viability of vendors of software applications requires that such licenses be difficult to circumvent in other instances, such as when no equivalent application but only a more valuable application is available for a particular computing platform of a new UE. Very small applications also may have a small licensing royalty that is only feasible if such licensing transactions and distributions can occur without an undue amount, or perhaps any, customer support to the user.

Each of these considerations is particularly apt to portable wireless telephones, for example, that further include cellular telephones that communicate voice and data packets over wireless networks. Further, many such cellular telephones are being manufactured with relatively large increases in computing capabilities, and as such, are becoming tantamount to small personal computers and hand-held PDAs. However, these smaller personal computing devices can be severely resource constrained. For example, the screen size, amount of available memory and file system space, amount of input and output capabilities and processing capability may each be limited by the small size of the device. Because of such severe resource constraints, it is often desirable, for example, to maintain a limited size and quantity of software applications and other information residing on such remote personal computing devices, e.g., client devices. As such, the computing platforms for such devices are often optimized for a particular telephone chipset and user interface hardware. The licensing may envision short duration download and a limited number of uses, rather than the paradigm of buying computer software on a CDROM that is loaded onto a personal computer for an essentially unlimited duration and is compatible with a large population of operating systems.

### SUMMARY

The following presents a simplified summary in order to provide a basic understanding of some aspects of the disclosed versions. This summary is not an extensive overview and is intended to neither identify key or critical elements nor delineate the scope of such versions. Its purpose is to present some concepts of the described versions in a simplified form as a prelude to the more detailed description that is presented later.

In one aspect, a method for transacting and transferring a computer-implemented application related to a currently licensed application begins with determining license rights held by a user for an original application executed by a first user device having a first configuration suitable to execute the application. The original application is mapped by a mapping business rule to a substitute application suitable for execution on a second user device having a second configuration. A pricing business rule is applied to price a transaction for licensing the user to use the substitute application in lieu of using the original application. Then the transaction is concluded by provisioning the second user device with the substitute application. Automating the selection of a suitable replacement application and automating the pricing for this transferring license rights seamlessly provides for users to switch between user devices without undue expense or inconvenience. In addition, a network that supports these user devices is not burdened with the expenses of manually calculating a value for these transfers and causing the distribution.

In other aspects, a processor, a computer program, and an apparatus have means for performing the afore-mentioned method for transacting and transferring the computer-implemented application in support of user devices.

In yet another aspect, an apparatus has a transfer management component that determines license rights held by a user for an original application executed by a first user device having a first configuration suitable to execute the application. An application catalog maps in accordance with a mapping business rule the original application to a substitute application suitable for execution on a second user device having a second configuration. A rule engine applies a pricing business rule to price a transaction for licensing the user to use the substitute application in lieu of using the original application. A distribution component concludes the transaction by provisioning the second user device with the substitute application.

In yet a further aspect, a method for transacting and transferring a computer-implemented application related to a currently licensed application begins with a request for a determination of license rights held by a user for an original application executed by a first user device having a first configuration suitable to execute the application. Mapping of the original application to a substitute application suitable for execution on a second user device having a second configuration in accordance with a mapping business rule is accepted. A transaction price which was determined by applying a pricing business rule to price a transaction for licensing the user to use the substitute application in lieu of using the original application is accepted. The transaction is concluded by receiving provisioning of the second user device with the substitute application.

In further aspects, a processor, a computer program, and an apparatus have means for performing the afore-mentioned method for transacting and transferring the computer-implemented application in a user device.

In yet another aspect, an apparatus includes a communication component for requesting a determination of license rights held by a user for an original application executed by a first user device having a first configuration suitable to execute the application. A user interface accepts a mapping in accordance with a mapping business rule of the original application to a substitute application suitable for execution on a second user device having a second configuration and for accepting a transaction price which was determined by applying a pricing business rule to price a transaction for licensing the user to use the substitute application in lieu of using the original application. The communication component concludes the transaction by receiving provisioning of the second user device with the substitute application.

To the accomplishment of the foregoing and related ends, one or more versions comprise the features hereinafter fully described and particularly pointed out in the claims. The following description and the annexed drawings set forth in detail certain illustrative aspects and are indicative of but a few of the various ways in which the principles of the versions may be employed. Other advantages and novel features will become apparent from the following detailed description when considered in conjunction with the drawings and the disclosed versions are intended to include all such aspects and their equivalents.

### BRIEF DESCRIPTION OF THE DRAWINGS

FIG. 1 is a high level system diagram of a transfer system according to one aspect;

FIG. 2 is a methodology for performing transfer of applications and other items that form a dynamic inventory of a user equipment (UE) of the transfer system of FIG. 1, according to one aspect;

FIG. 3 is a methodology for imposing business rules for upgrading or cross selling applications to users transferring dynamic inventory from one UE to another UE, according to one aspect;

FIG. 4 is an exemplary UE for transferring applications in accordance with the methodology of FIG. 2, according to one aspect;

FIG. 5 is an exemplary transfer server for the transfer system of FIG. 1, according to one aspect;

FIG. 6 is an exemplary data structure for a dynamic inventory of licensed applications maintained by the UE of FIG. 1, according to one aspect;

FIG. 7 is an exemplary data structure for a repository of licensed transactions per subscriber maintained by the transfer system of FIG. 1, according to one aspect;

FIG. 8 is an exemplary data structure for an application catalog accessed by the transfer system of FIG. 1, according to one aspect;

FIG. 9 is an exemplary matrix embodying business rules utilized by the transfer system of FIG. 1, according to one aspect;

FIG. 10 is an exemplary communication system including entities that form a distributed transfer system, according to one aspect;

FIG. 11 is a timing diagram for an originating UE containing a transfer client and dynamic inventory that is to be transferred with coordination among other entities of the distributed transfer system of FIG. 10, according to one aspect;

FIG. 12 is a timing diagram for an originating UE that is unavailable but that contains licensed applications that need to be transferred to a destination UE, according to one aspect;

FIG. 13 is a timing diagram of a distributed transfer system downloading licensed applications to a destination UE that does not contain a transfer client, according to one aspect;

FIG. 14 is a timing diagram of a distributed transfer system downloading licensed applications to a destination UE after an originating UE is unavailable to initiate the transfer, according to one aspect;

FIG. 15 is a timing diagram of a distributed transfer system downloading licensed application to a destination UE that does not include a transfer client, according to one aspect; and

FIG. 16 is a diagram of a communication system incorporating a digital locker for the licensed applications, according to one aspect.

### DETAILED DESCRIPTION

Transfer management of licensed applications from an original user equipment (UE) device to a destination UE device is facilitated by a communication network that tracks the inventory of software application that have been previously licensed, and suggests a suite of applications equivalent to, an upgraded version of, or an appropriate cross sell opportunity for a configuration (e.g., chipset and operating system) of a destination UE device (e.g., cellular telephone able to run applications such as games, media players, and personal organizers, etc.). Business rules automate application mapping and pricing appropriate for the proposed configuration to automate and increase the convenience for both the user and provider. Once accepted, the appropriate executable code is distributed to the destination UE device, appropriate pro-rated billing is initiated, and the prior licensed applications either locked for subsequent transfer back with minimal impact to a throughput limited communication channel or commanded to automatically delete to enforce a permanent transfer, especially for a lost or stolen original UE device.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to concisely describing these versions.

In the following description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

The apparatus and methods are especially well suited for use in wireless environments, but may be suited in any type of network environment, including but not limited to, communication networks, public networks, such as the Internet, private networks, such as virtual private networks (VPN), local area networks, wide area networks, long haul networks, or any other type of data communication network.

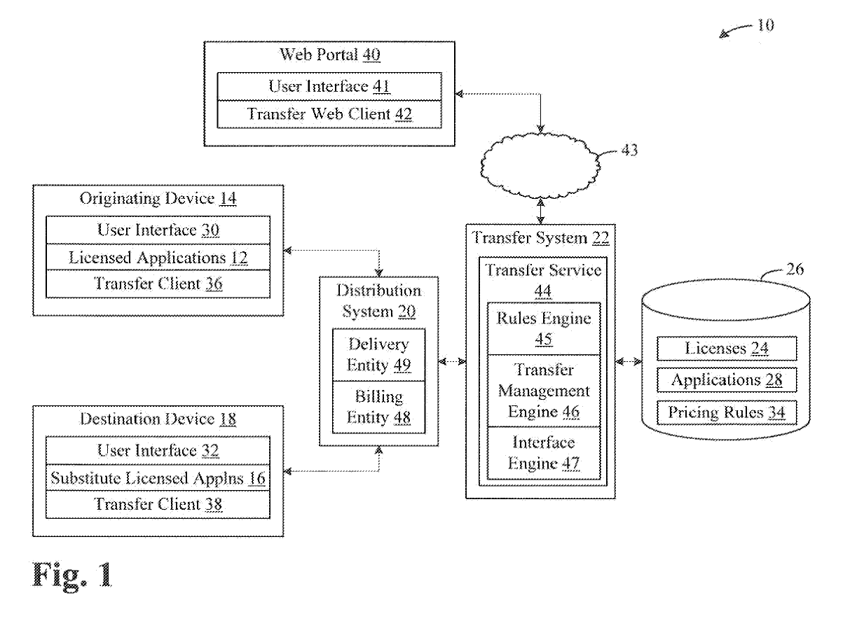

Referring to FIG. 1, a communication network 10 provides a license cognizant distribution of licensed applications 12 to an original device 14 with subsequent automated transfer of the license and distribution of a substitute licensed application 16 suitable for use on a destination device 18. In the subject description, the term “application” may also include files having executable content, such as object code, scripts, byte code, markup language files, and patches. In addition, an “application” referred to herein, may also include files that are not executable in nature, such as documents that may need to be opened or other data files that need to be accessed.

A distribution system 20 that communicates with the original and destination devices 14 and 18 to effect the distribution of applications 12 and 16 coordinates with a transfer system 22 that validates the existing license rights of the originating device 14 against a license transaction database 24 in a repository 26. For clarity, security features and other communication features are associated with the distribution system 20 and transfer of applications and license rights are depicted as segregated in the transfer system 22, although such features may be fully integrated and not readily distinguishable. In the exemplary version, the transfer system 22 is operable to provide the decision-making and logic for managing licenses and pricing associated with distribution of content being transferred.

To that end, the transfer system 22 proposes the substitute licensed applications 16 drawn from an application catalog 28 as being equivalent or an appropriate upgrade or replacement for the licensed applications 12. The transfer system 22 negotiates a proposed price with the user via the distribution system and a user interface 30 on the originating device 14 or a user interface 32 on the destination device 18 for the substitute licensed applications 16 based upon existing license rights and upon prevailing business rules 34. The transfer system 22 updates the license transaction database 24 for reporting to vendors of the applications and future transfer validations. A transfer client 36 on the originating device 14 facilitates locking or deletion of the applications 12 and a transfer client 38 facilitates installation and activation of the substitute licensed applications 16 on the destination device 18.

A web portal system 40 has a user interface 41 through which a user can initiate a transfer of dynamic inventory (e.g., applications 12) on the original device 14, initiate a credit back for applications 12 that are to be inactivated on the original device 14 with no immediate plan to transfer to a destination device 18, or initiate a transfer to a destination device 18. The web portal system 40 includes a web transfer client 42 that provides the proper protocol across a network 43 (e.g., Wireless over the Air network) in order to communicate with the transfer system 22.

In an illustrative aspect, the transfer system 22 (e.g., a server) includes a transfer service 44 which includes a rules engine 45, a transfer management engine 46, and an interface engine 47. According to one aspect, the rules engine 45, the transfer management engine 46, and the interface engine 47 of the transfer system 22 are in communication. The rules engine 45 is operable to specify rules and logic for controlling content and license transfers. In one example, the rules engine 45 operates to stand alone in the transfer system 22. In such an example, the rules engine 45 may not be in communication with the distribution system 20 or the originating device 14 and the destination device 18.

The transfer management engine 46 is operable to query the distribution system 108 so as to determine the purchase history of the content being transferred. The transfer management engine 46 is further operable to query the distribution system 20 for a usage history of the content by the originating device 14. In one instance, the transfer management engine 46 initiates and controls the querying of the distribution system 20 so as to determine the license information for the applications 12. Based on the obtained license information and knowledge of the purchased applications, the transfer system 22 is further operable to distribute the applications 16 being transferred to the destination device 18. The transfer management engine 46 is further operable to query the distribution system 20 to determine the usage of limited use content and adjust usage of limited use content accordingly. In one example, the transfer management engine 46 is further operable to add additional rules for application distribution. The transfer management engine 46 can further request that the originating device 14 delete the transferred application 12 from the originating device 14.

The interface engine 47 provides interfaces to the originating device 14 and destination device 18 so that the end user can view the originating device applications 12. The interface engine 47 further provides an interface to an administrator to view and define rules for transferring the application 12 from the web portal 40. In one example, during operation, the transfer clients 36 and 38 interact with the interface engine 47.

The distribution system 20 includes a billing entity 48 and a delivery entity 49. The delivery entity 49 operates to deliver the transferred content to the destination device 18. In one example, the billing entity 48 passes through information of the content purchased for billing purposes. In one example, the content being transferred may be associated with an unlimited license. In such a scenario, the license associated with the transferred application 16 may be associated with the destination device 18.

In a scenario wherein the application being transferred is associated with a limited-usage license, the transfer management engine 46 may operate so as to query the originating device 14 or the billing entity 48 to determine the number of licenses still available for use. Upon determining the number of available licenses, the delivery entity 49 operates to transfer the remaining usage licenses to the destination device 18.

In one example, the transfer management engine 46 communicates with the billing entity 48 and the delivery entity 49. The interface engine 47 communicates with the originating device 14 and destination device 18 through device user interface 30 or the web user interface 41. The interface engine 47 further communicates with the administrator. In one example, the administrator manages and controls the operations, administration, and management of the system, such as through the web portal 40.

In this manner, the transfer system 22 is operable to backup, restore, and transfer applications between devices 14 and 18 having different capabilities, each have different executable binary code. By way of example, the executable binary code for the originating device applications 12 may be different from the executable binary code for the destination device 18. In one example, the transfer system 22 operates to provide the destination device 18 an executable binary code that can be executed on the destination device 18 but is equivalent to the executable binary code of the applications 12 for the originating device 14.

Additionally, in one instance, the transfer system 22 operates to transfer applications by utilizing information on the distribution system 20 based on the history and knowledge of the application family. Further, the transfer system 22 operates to provide configurable rule-based content mapping for target applications on the destination device 18. Yet further, the transfer system 22 operates to utilize a set of rules to determine the mapping format. Still further, the transfer system 22 operates to perform content mapping based on purchase history, family mapping, pricing information, etc.

Furthermore, the transfer system 22 operates to provide an automated content transfer feature that is triggered by the registration of the new device 18 substantially without any user intervention. In one aspect, once a new device 18 is initially connected to the network 10, the new device 18 goes through a registration process so as to establish connection between the device 18 and the network 10. In this manner, once the connection of the new device 18 is confirmed, applications 16 can be transferred from the originating device 14 to the destination device 18 without any user interaction or minimal user interaction.

Moreover, the transfer system 22 operates to provide multi-tiered pricing support for content upgrade, cross-sell, and up-sell during the content transfer operation. Furthermore, the transfer system 22 provides the inclusion of usage count for limited-use applications in an application transfer operation. In one example, the usage count may be counted during the content mapping.

Yet further, the transfer system 22 provides auto-deletion of transferred applications 16. In one aspect, once the applications have been transferred to the destination device 18, the applications 12 are automatically deleted from the originating device 14 without any user intervention. Still further, the transfer system 22 provides programmatic auto-discovery of application inventory based on both the device 14 and backend transaction records (e.g., licenses 24). In one instance, the transfer system 22 programmatically determines the applications 12 residing on the originating device 12, the licenses residing on the purchase history (e.g., licenses 24), and reconciling the two into one set of information to determine the application mapping.

It should be appreciated with the benefit of the present disclosure that transferring applications 12 from the originating device 14 to the destination device 18 can be achieved without copying the application 12 being transferred. Rather, in one aspect, transfer of application 12 is affected using the license information associated with the application 12 of the originating device 14. In this scenario, a user of the originating device 14 initiates transfer of applications 12 by communicating a request for transfer of content from the originating device 14 to the destination device 18 to the transfer system 22 via the distribution system 20. The transfer system 22 obtains the license information 24 associated with the applications 12. After receiving the licensing information 24, the transfer system 22 requests that the content being transferred be deleted from the originating device 14 via the distribution system 20. The transfer system 22 also asks the distribution system 20 to transfer the applications 16 to the destination device 18. Upon affecting the transfer, the user can access the transferred applications 16 on the destination device 18.

Some or all of the user interfaces 30, 38, and 41 on the devices 14 and 18 or web portal 40 respectively can display upgrade pricings of a upgrades mapped from the applications 12 and confirm the transfer. Prices for equivalent applications can also change with time warranting update pricing to be displayed for acceptance on the user interfaces 30, 38, and 41. The payment method for the transferred applications can be in terms of subscription pricing, unlimited license purchases, or limited license purchases with some restrictions that is to be displayed to the user prior to accepting the transfer. Equivalent applications can be transferred without an intervening user display and acceptance step in some applications.

In one example, application content equivalence refers to displaying an available application 16 that could be offered to replace an existing application 12. Authentication and authorization for Web access via the web portal 40 can be included for all accesses to transfer system 22 and services 44 from the web by end users/administrators/operators with the application provider (not shown). In one example, multiple levels of permissions may be required for administration and operations. Transfer authorization by operators refers to authorization mechanism for all the transfers by operators. Secured client/server communication for the application transfer process can provide a secured communication path for the transfer clients 32, 38, and 41 and content transfer server connections.

The applications database 28 can comprise an operator catalog that provides an interface for operators to define the devices 18 where applications 16 can be transferred. The transfer management engine 46 can provide an administrative interface to define the transfer business rules. Controlled delivery of applications provides an option for the operators to manage the delivery of content through the UE shopping user interface or an auto install process.

The transfer system 22 advantageously enables a user to purchase a new device 18 or replace the lost/damaged devices 14, yet be credited for the applications 12 on the old device 14. Furthermore, the transfer system 22 enables the user to purchase a device 18 online via web portal 40, yet be able to transfer applications 12 from the old device 14 to the new device 18 using the web portal 40. Still further, the transfer system 22 enables the user to periodically backup applications 16 of the user's device 14 for safekeeping or as storage area for future reuse. Additionally, the operators may add new applications 16 to the new device 18 using the transfer system 22.

It should be appreciated with the benefit of the present disclosure that such seamless migration of licensed content (e.g., application executable code) may occur in a wired or wireless scenario, including wireless data packet communication such as IEEE 802.11 or data communications over a telephone network. Furthermore, the transfer of applications can further comprise any type of content, both user-generated and purchased, from the originating device 14 to a destination device 18. The content being transferred can include applications, application data, digital rights management (DRM) content, and non-DRM content. Without any limitations, exemplary content that may be transferred can be ringers, wallpapers, music, address book, pictures, videos, Short Message Service (SMS), application meta-data, etc.

It should be appreciated that the transfer facilitated by the transfer system 22 can be activation codes or similar enabling transfers. Bundled applications already installed but not activated on the destination device 18 can have additional security provisions over being required to be transmitted or such bundling can reduce transmission loads on the communication network 10, increase the user experience by reducing the time required to install an application, and/or facilitate rapid changes in license rights from a demonstration of limited uses or limited features during use to a more unlimited license.

In an exemplary version, both the originating and destination devices 14 and 18 are BREW-enabled. The Binary Runtime Environment for Wireless® (BREW®) software, developed by Qualcomm Incorporated of San Diego, Calif., exists over the operating system of a computing device, such as a wireless cellular phone. BREW® can provide a set of interfaces to particular hardware features found on computing devices.

It should be appreciated that additional interfaces can be included for verifying that users are complying with licensed applications by not manually circumventing application lock-outs or downloading unauthorized applications, etc. Security features can be facilitated by the transfer system 22 such as providing a conduit for new applications to be stored in executable form, cross referenced to existing and new device configurations supported by the communication network 10, etc.

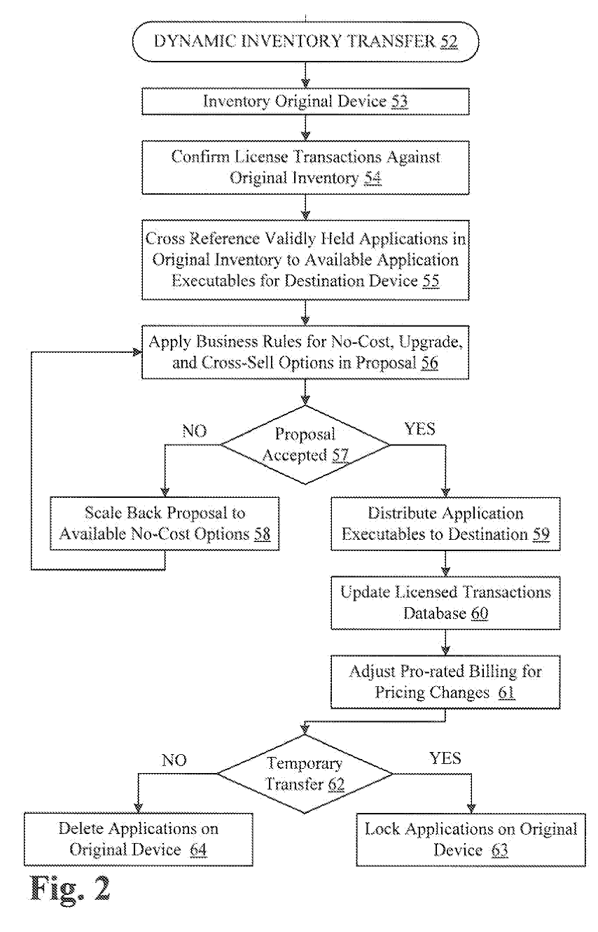

In FIG. 2, a methodology 52 of dynamic inventor transfer between user equipment devices (e.g., cell phones, handheld integrated messaging devices, personal digital assistants, handheld general purpose computers, etc.) begins in block 53 by inventorying licensed content (e.g., application executable code) on an original device. License transactions are confirmed to establish these applications on the original device as validly licensed in block 54. In one aspect, transferring of these valid applications to which a user is entitled to use to a destination device, which can be built upon a different computing platform (e.g., chipset, operating system), requires a mapping of original applications to those that can be distributed and that will operate on the destination device. Thus, in block 55, a cross reference is made to an application catalog to determine whether an equivalent version, an upgrade version, or an alternative offering in the same category (e.g., game, personal organizer, media player, etc.) can be distributed. In block 56, business rules are applied in order to automatically propose a configuration that is appropriately configured in order to transfer the licensed applications, perhaps with equivalent, upgraded, or alternative versions. In block 57, if the user does not accept the proposed configuration, then an alternative proposal is made available, which in the illustrative version is depicted as being those applications that can be distributed at no additional cost over the current value of the licensed applications in the original device (block 58) and processing returns to block 57. It should be appreciated that in some instances such conversions may entail pre-approved business rules such that the user has agreed to incur the costs for upgrades as they become available. With the proposed dynamic inventory of licensed applications for the destination device accepted in block 57, in block 59, this dynamic inventory is distributed, perhaps in executable format for optimized operation on the destination device. The database of transactions that substantiates valid licenses is updated to reflect this transfer in block 60. The billing cycle is pro-rated in block 61 to reflect the date of the transfer for those licenses that are paid by an on-going subscription and are affected by a change in subscription price. In block 62, a determination is made as to whether this transfer is intended to be temporary (e.g., user chooses to use one of a plurality of devices for an outing). If so, the application can be advantageously locked on the original device in block 63 to reduce communication overhead in the future to transfer the application back to the original device. If deemed a permanent transfer in block 62, then the application on the original device is deleted in block 64. Such deletion can occur as an automated feature, which can be desirable in situations where the user is no longer in control of the original device (e.g., lost or stolen). If the original device is not operable or not communicating with the network, such pending deletion action can be deferred until the device reestablishes communication or is powered up.

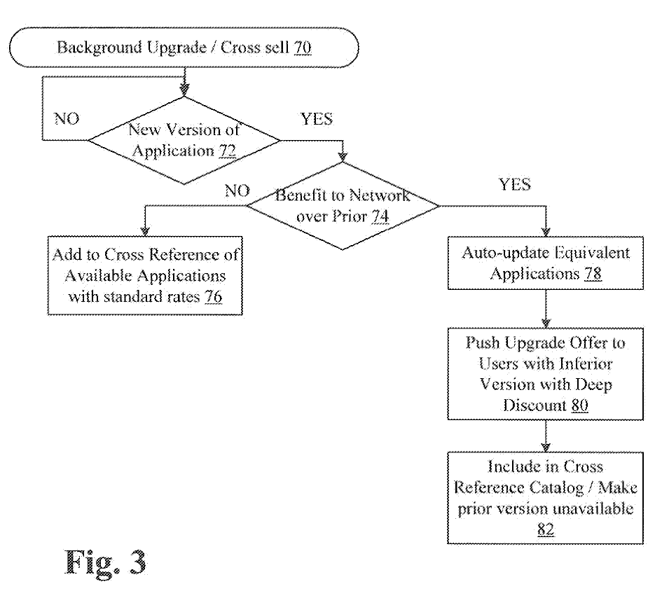

In FIG. 3, an exemplary methodology 70 for transferring dynamic inventory (e.g., applications) when opportunities arise for upgrades or cross selling, and in particular to a process performed in the background with respect to a user. When it is determined in block 72 that a new version of an application is available, then a determination is made as to whether there is a benefit to the network over a prior version of the application (block 74). For example, some applications may impose a communication burden on a carrier portion of an overall network, be susceptible to malicious software intrusion that would not only harm the reputation of an application developer but could also degrade a carrier network performance, cause equipment malfunctions that would impair the reputation of an original equipment manufacturer (OEM) but also give rise to overall dissatisfaction with network services if mistakenly blamed on the carrier or operator of the network, etc. As another example, an older version of an application could push more reporting and processing toward the network that with later improvements in UEs gets handled in a distributed fashion, thus giving a benefit to the network. Consequently, rather than waiting for a user pull for a replacement of such a prior application, in block 78, an auto-update can be initiated for equivalent applications that are fielded. In some instances, the new version may be deemed a significant upgrade and not merely an equivalent application. For example, the vendor for the new application may not agree to a no-cost installation for those with a prior version. In block 80, since the network still would benefit from users choosing to transfer the application to the current device, advertising channels are utilized to push the option to the users, perhaps with a deep discount to encourage acceptance. Then, the new application is included in cross reference catalogs in block 82. The business rules applicable to this application can make this application the preferred option to propose to future transfers of applications and further may make the prior version unavailable for future purchases for those platforms supported by the new version. If back at block 74, the new version does not have a benefit for the network, then the application is added to a cross reference of available applications with standard application of business rules regarding purchase or subscription rates.

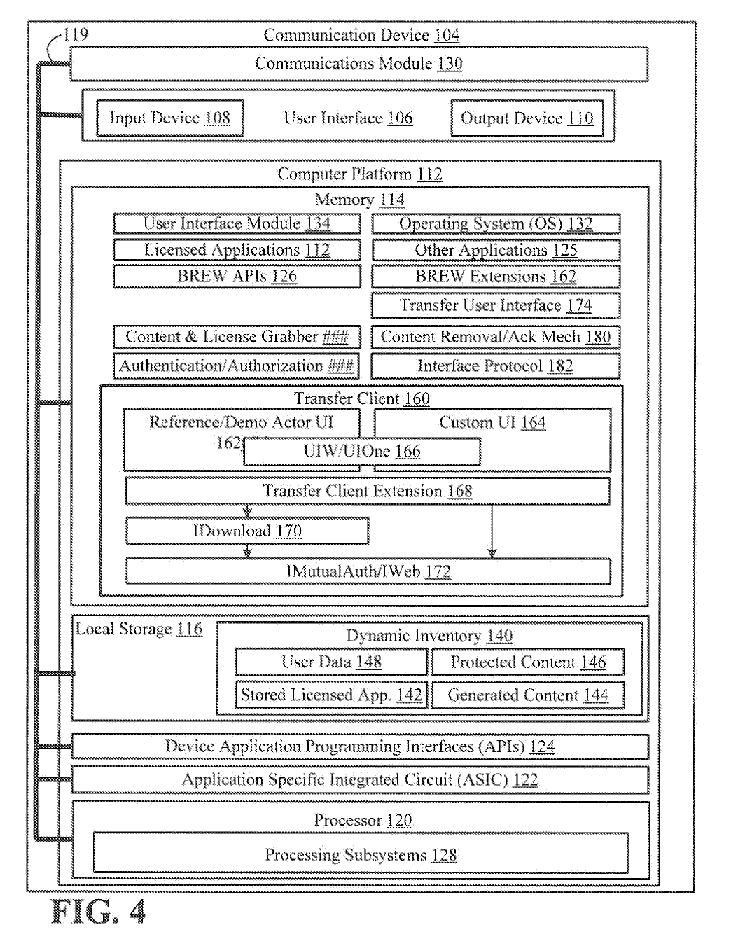

In FIG. 4, an exemplary version of a communication system 104 is depicted according to some aspects as any type of computerized device, such as the originating or destination device 14 of FIG. 1. For example, the communication device 104 may comprise a mobile communication device, such as a wireless and/or cellular telephone. Alternatively, the communication device 104 may comprise a fixed communication device, such as a Proxy Call/Session Control Function (P-CSCF) server, a network device, a server, a computer workstation, etc. It should be understood that communication device 104 is not limited to such a described or illustrated devices, but may further include a Personal Digital Assistant (PDA), a two-way text pager, a portable computer having a wired or wireless communication portal, and any type of computer platform having a wired and/or wireless communications portal. Further, the communication device 104 can be a remote-slave or other similar device, such as remote sensors, remote servers, diagnostic tools, data relays, and the like, which does not have an end-user thereof, but which simply communicates data across a wireless or wired network. In alternate aspects, the communication device 104 may be a wired communication device, such as a landline telephone, personal computer, set-top box or the like. Additionally, it should be noted that any combination of any number of communication devices 104 of a single type or a plurality of the afore-mentioned types may be utilized in a cellular communication system (not shown). Therefore, the present apparatus and methods can accordingly be performed on any form of wired or wireless device or computer module, including a wired or wireless communication portal, including without limitation, wireless modems, Personal Computer Memory Card International Association (PCMCIA) cards, access terminals, personal computers, telephones, or any combination or sub-combination thereof.

Additionally, the communication device 104 may include a user interface 106 for purposes such as requesting, interacting with, and/or playing the media content 14. This user interface 106 includes an input device 108 operable to generate or receive a user input into the communication device 104, and an output device 110 operable to generate and/or present information for consumption by the user of the communication device 104. For example, input device 106 may include at least one device such as a keypad and/or keyboard, a mouse, a touch-screen display, a microphone in association with a voice recognition module, etc. In certain aspects, input device 108 may provide for user input of a request for content or for user input of a request for additional information. Further, for example, output device 110 may include a display, an audio speaker, a haptic feedback mechanism, etc. Output device 110 may generate a graphical user interface, a sound, a feeling such as a vibration, etc., and such outputs may be associated, for example, with the use of a licensed application 111.

Further, communication device 104 may include a computer platform 112 operable to execute applications to provide functionality to the device 104, and which may further interact with input device 108 and output device 110. Computer platform 112 may include a memory, which may comprise volatile and nonvolatile memory portions, such as read-only and/or random-access memory (RAM and ROM), erasable programmable read-only memory (EPROM), electrically erasable programmable read-only memory (EEPROM), flash memory, and/or any memory common to computer platforms. Further, memory may include active memory and storage memory, including an electronic file system and any secondary and/or tertiary storage device, such as magnetic media, optical media, tape, soft and/or hard disk, and removable memory components. In the illustrative version, memory is depicted as RAM memory 112 and a nonvolatile local storage component 116, both each connected to a data bus 119 of the computer platform 112.

Further, computer platform 112 may also include a processor 120, which may be an application-specific integrated circuit (ASIC), or other chipset, processor, logic circuit, or other data processing device. In some aspects, such as when communication device 104 comprises a cellular telephone, processor or other logic such as an application specific integration circuit (ASIC) 122 may execute an application programming interface (API) layer 124 that interfaces with any resident software components, depicted as other applications 125 that may be active in memory 114 for other functions (e.g., communication call control, alarm clock, text messaging, etc.). It should be appreciated with the benefit of the present disclosure that applications consistent with aspects of the present invention may omit other applications and/or omit the ability to receive streaming content such as voice call, data call, and media-related applications in memory 114. Device APIs 124 may be a runtime environment executing on the respective communication device. One such API 124 runtime environment is BREW® API 126 depicted separately and developed by QUALCOMM Incorporated of San Diego, Calif. Other runtime environments may be utilized that, for example, operate to control the execution of applications on wireless computing devices.

Additionally, processor 120 may include various processing subsystems 128 embodied in hardware, firmware, software, and combinations thereof, that enable the functionality of communication device 104 and the operability of the communication device 104 on communications system 100. For example, processing subsystems 128 allow for initiating and maintaining communications, and exchanging data, with other networked devices as well as within and/or among components of communication device 104. In one aspect, such as in a cellular telephone, processor 120 may include one or a combination of processing subsystems 128, such as: sound, non-volatile memory, file system, transmit, receive, searcher, layer 1, layer 2, layer 3, main control, remote procedure, handset, power management, diagnostic, digital signal processor, vocoder, messaging, call manager, Bluetooth® system, Bluetooth® LPOS, position determination, position engine, user interface, sleep, data services, security, authentication, USIM/SIM (universal subscriber identity module/subscriber identity module), voice services, graphics, USB (universal serial bus), multimedia such as MPEG (Moving Picture Experts Group) protocol multimedia, GPRS (General Packet Radio Service), SMS, short voice service (SVS™), web browser, etc. For the disclosed aspects, processing subsystems 128 of processor 120 may include any subsystem components that interact with applications executing on computer platform 112.

Computer platform 112 may further include a communications module 130 that enables communications among the various components of communication device 104, as well as being operable to communications related to licensed applications 111. Communications module 130 may be embodied in hardware, firmware, software, and/or combinations thereof, and may further include all protocols for use in intra-device and inter-device communications. Further, communications module 130 is operable to transmit and/or receive information, such as requesting and receiving licensed application 111 in accordance with the apparatus and methods described herein.

Certain of these capabilities of the communication device 104 can be facilitated by code loaded from local storage 116, retained in memory 114, and executed by the processor 120, such as an operating system (OS) 132. A user interface module 134 facilitates interactive control with the user interface 106. In addition, dynamic inventory 140 that customizes the features of the communication device 104 can include stored copies 142 of licensed applications 112 (e.g., both licensed and unlicensed, executable and/or interpreted code), application generated content 144, distribution protected content 146, and user data 148. Without any limitations, examples of application-generated content 144 may be settings, application generated data, user interface settings, service settings, etc. Distributed protected content 146 may be ringtones, wallpaper, themes, game levels, scores, DRM protected content (e.g., music, video, etc.), application state, application data, etc. User data 148 may include user generated content or device core content (generated or otherwise). User generated content 144 may include pictures, video, etc., while device core content may include contacts, calendar, phone settings, ringtone associations, SMS (i.e., cellular phone text messaging), messages, call logs, network setting, etc.

The BREW APIs 126 provide the ability for applications to call Device APIs 124 and other functions without having to be written specifically for the type of communication device 104. Thus, a licensed application 112 may operate identically, or with slight modifications, on a number of different types of hardware configurations within the operating environment provided by BREW API 126, which abstracts certain hardware aspects. A BREW extension 150 adds additional capability to the programming platform of the BREW API 126, such as offering MP3 players, Java Virtual Machines, etc. A uiOne™ architecture developed by QUALCOMM Incorporated as part of BREW provides a set of BREW extensions that enable rapid development of rich and customizable UIs (i.e., active content, over-the-air (OTA) upgradeable), helps to evolve download business beyond applications, provides theming of part or entire handset UI, and utilizes BREW UI Widgets. Thus, BREW uiOne reduces the time to market for handsets, carrier customization, and consumer personalization. To do this, the BREW uiOne provides a clear set of abstractions, adding two new layers to the application development stack for BREW. In the illustrative version, an exemplary device transfer client 160, according to one aspect includes a reference/demo Actor user interface (UI) 162, a custom user interface 164, and user interface Widget (UIW) 166. In one example, the user interface 164 is a BREW user interface Widget, the transfer extension 168, IDownload 170, and the IMutualAuth/IWeb 172. As illustrated, the device transfer extension 168 is capable of sending data to IDownload 170 and the IMutualAuth/IWeb 172. In the same manner, the IDownload 170 is capable of sending data to the IMutualAuth/IWeb 172.

The transfer client 160 initiates reusing credit back logic for an application 112. The reference/demo Actor UI 162 sends an application transfer request to the transfer extension 168. The transfer extension 168 sends a download request to the IDownload 170, which is followed by the IDownload 170, providing the number of remaining reuses to the transfer extension 168. The transfer extension 168 then sends messages to the IDownload 170 and a mutual authentication (MA)/web device (not shown) to determine the number of downloads remaining, and further requesting the deletion of the remaining downloads in the communication device 104. The client 160 is thereafter notified.

Similarly, a transfer client 160 of a destination communication device 104 is initiated, according to one example. The transfer extension 168 receives a message to show all the user's applications. The transfer extension 168 sends a message to MA/Web requesting the desired information. After receiving the user's application list, the transfer extension 168 sends a message to the user. Upon receiving the items selected to be transferred by the user, the transfer extension 168 sends a message to the MA/Web. After the transfer extension 168 has been notified, the transfer extension 168 sends a request to the IDownload 170 to initiate downloading of the selected items. The IDownload 170, in turn, communicates to the MA/Web so as to obtain the selected items. Once the items have been downloaded successfully, the transfer extension 168 is notified. Other components for transferring licensed applications 112 are facilitated by other components resident in memory 114 for execution by the processor 120, including a transfer user interface component 174 for utilizing the user interface 160 to interact with the user. In addition, content and license grabber component 176 assists in inventorying licensed applications 112 stored on the communication device 104. An authentication and authorization component 178 performs the device portion of mutual authentication with other components of a communication network 10 (FIG. 1). A content removal and acknowledgement mechanism 180 responds to commands to delete the licensed applications 112 after transfer to a destination communication device 104. An interface protocol 182 provides the necessary protocol conversions between the communication device 104 and other components of the communication network 10.

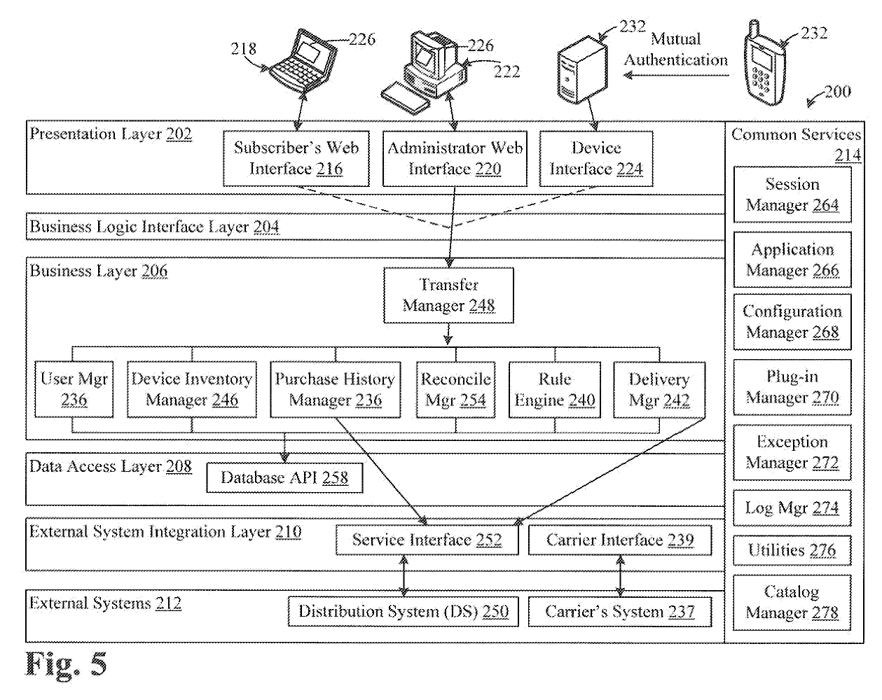

In FIG. 5, an exemplary transfer server 200 that performs the functions of the transfer system 22 of FIG. 1, according to one aspect, includes a presentation layer 202, a business logic interface layer 204, a business layer 206, a data access layer 208, an external system integration layer 210 that links to external systems 212, and a common services component 214. In one example, the presentation layer 202 can use the Java server faces, the business layer 206 uses Java 2, Enterprise Edition (J2EE), the common services 214 uses J2EE, the external system integration layer 210 uses pure J2EE, and the data access layer 208 uses DAO or torque generated DAO.

The presentation layer 202 of the transfer server 200 can be web tier and device tier. The presentation layer 202 provides interfaces for different types of clients (e.g., mobile device, Internet browser, etc.). The presentation layer 202 includes a subscriber's web interface 216 linked to a subscriber web-capable device 218, an administrator web interface 220 linked to an administrator web-capable system 222, and a device interface 224. The subscriber web interface 216 allows the user to access the transfer system 22 as provided by the transfer server 200 using a web browser 226. The administrator web interface 220 allows the configuring and managing of the content transfer process using a web browser 228. The device interface 224 allows the device user to access the transfer server 200 using the user's device 230 via mutually authenticate communication through a MA proxy 232. In one example, the device interface may include generation of web pages as well as interpreting user requests.

According to one example, the transfer server 200 provides standard/reference presentation, which contains simple web pages. In one example, the presentation layer 202 is implemented using Java Server Faces Framework. According to one example, the carrier (or content provider) can implement the carrier's own presentation logic, which can be easily mapped into business logic incorporated into the business layer 206.

The business logic interface layer 204 defines the interfaces implemented to separate the presentation logic incorporated into interfaces 216, 220, and 224 from business logic incorporated into the business layer 206. The business logic interface layer 204 enables the transfer server 200 to be deployed as standalone server or be implemented as web-services. In one instance, the business logic interfaces 204 may be grouped based on respective functionalities, thus making deployment of the transfer system 22 more flexible.

The business layer 236 includes a user manager 236 that has an API authenticateUser(uname, passcode) that validates user's credential (e.g., username and password). The user manager 236 has an API newRegistration( ) that creates new user and has an API mapUserIDToSid( ) that maps user ID to subscriber ID. A user ID can be a mobile directory number (MDN), mobile identification number (MIN), etc. A carrier system 237 of the external systems 212 provides the mapping and is interfaced to the external system integration layer 210 by a carrier interface 239. A purchase history manager 238 of the business layer 206 has an API getSIDPurchasedApplications( ) that gets the list of applications (or content) purchased by subscriber. The list consists of applications, which are presently installed on the device, as well as applications deleted by subscriber previously. A rule (engine) manager 240 of the business layer 206 has an API getApplicationMappings(appsList) that gets a list of applications (or content) that can be transferred to new device, after applying a transfer rule (e.g., mapping licensed applications to a substitute application going to a destination or determining a transfer price). The rule (engine) manager 240 also has an API getDefaultPriceOptions(appid, pid) that when mapped application (or content) has more than one price option, then presentation logic of this function can determine a default price option. This function is useful during MA registration. In one example, during MA registration, the user may not have an option to choose price options. A delivery manager 242 of the business layer 206 has an API deliverApplications(appsList) that makes alternate purchase request for each application (or content). A device manager 244 of the business layer 206 has an API validateDeviceID(deviceID) that validates whether a device ID belongs to the carrier's network. The device manager 244 of the business layer 206 has an API ListgetAvailableDeviceID( ) that gets a list of devices available with carrier association. By using this API, the web interface can display available device IDs to the subscriber so the subscriber can perform a mock transfer. A device inventory manager 246 has an API SetDeviceLicenseInformation (list) that stores the list of applications (or content) retrieved from subscriber device.

The business layer 206 contains the transfer logic of the transfer system 22. In one example, the business layer 206 may be developed using Java. In one instance, the presentation layer 206 interacts with the business logic interface layer 204, the facade design pattern (not shown), and a transfer manager 248. According to one example, the transfer manager 248 provides a single entry point into the business layer 206. In one instance, the presentation layer 202 may interact with the modules in the business layer 206 using well-defined modules.

According to one example, the transfer manager 248 implements the interfaces defined by the business logic interface layer 204. The transfer manager 248 is responsible for interpreting requests from the client, loading appropriate request handlers, and redirecting output of request handlers to proper response class. The transfer manager 248 operates to extract the required parameter with value from the requests and hands over the parameter list to the request handlers.

The device inventory manager 246 is responsible for maintaining the license data for the content submitted by the device transfer client 160 (FIG. 3). The device transfer client 160 submits the license data when the transfer operation is initiated using the device transfer client 160. In one example, the device inventory manger 246 operates to store temporarily the license data in the memory and provides the API to retrieve the license data. In one example, the device inventory manager 246 implements a DeviceInventoryInterface interface. In another example, the device inventory manager 246 may operate to obtain the license data from the device in a web-initiated transfer.

The purchase history manager 238 is responsible for retrieving the list of content purchased by the subscriber. In one example, the history is retrieved from a distribution system 250 of the external systems 212 using a service interface 252 of the external system integration layer 210. The purchase history manager 238 operates to retrieve purchase or transaction history of the subscriber, retrieve purchased and deleted content of the subscriber, and provide the APIs needed to access the history. In one instance, the purchase history manager 238 retrieves the purchased yet deleted content using the service interface 252. According to one aspect, the transfer server 200 can retrieve the purchase history even if the device transfer client 160 is not present.

A reconcile manager 254 is responsible for maintaining a single list of the subscriber's downloaded content. The transfer server 200 has two sets of content lists; one list contains the purchase history and another list device the device content inventory. The reconcile manager 254 merges the two content list into a single content list. The reconcile manager 254 can save the reconciled content list in a database for future use. The reconcile manager 254 further provides the API to retrieve the saved content list. In one example, the reconcile manager 254 stores the reconciled content list into the local database. Once the content has been transferred from the transfer server 200 to the destination device 18 (FIG. 1), the reconcile manger 254 may remove the reconciled content list after a specified period. In one instance, the reconcile manager 254 operates to present the client the reconciled list. In one example, the reconcile manager 254 implements the API Interface ReconcileInterface.

The content transfer may depend on a transfer rule (e.g., mapping licensed applications to a substitute application going to a destination or determining a transfer price). The rule (engine) manager 240 implements and executes the rule during the content transfer process. In one instance, the rule (engine) manager 240 is responsible for deciding the target content for each source content. The implemented rules ensure that for each content in the list, a single content is mapped to the destination device 18. The rule (engine) manager 240 further operates to determine the best suitable content for the target destination device 18 by applying the transfer rule.

The rule (engine) manager 240 further allows an operator to set new transfer rules. In one example, when a content selected to be transferred is not available in the content provider's catalog, the operator may give full credit to the subscriber. The operator may also give partial credit to the subscriber based on a formula (e.g., logic available in Creditback content, etc.). In one example, a pricing method or the pricing basis may not be present. When the user has remaining licenses or licenses that have never been used, the operator may credit the remaining licenses, transfer all licenses, or transfer the remaining licenses only. There may be rules for new version, upgrade, or equivalence. In one instance, the carrier may decide which content to be used in place of a given content. In one example, the rule engine implements the interface AXMappingInterace.

After the target content has been determined, the next step is to deliver the content to the destination device. In one example, the delivery manager operates to deliver the transferred content to the destination device. The actual download of the target content to the destination device 18 is initiated by the destination device 18, in one example. The delivery manager 242 operates to create an alternate purchase request (event) for each transferred content and submits the alternate purchase request to the DS 250. In one instance, the delivery option is a configuration item. The content can be delivered using auto-install option, may be a snapshot delivered to the myApps directory in the destination device 18, etc. In one example, the delivery manager 242 implements the API DeliveryInterface interface.

The user manager 236 operates to manage the transfer server user account. In one example, the transfer server 200 may support the end user, the administrator, and the business user. The end user can transfer content and use certain complimentary services. The administrator can perform day-to-day activities (e.g., content transfer, adding new user setting privileges for a user, etc.), backup, generate reports, and use some complementary services. The business user can transfer content, generate report, set transfer rule, and use some complementary services. In one instance, by default, the transfer server 200 can have one super user who can perform all activities listed above. The subscriber needs to register with the transfer server 200. In one example, the user manager 236 implements the API UserAccountInterface.

The data access layer 208 provides abstractions for the database in a database API 258 (e.g., hides the complexity of the underlying database mechanism). The data access layer 208 operates to provide for mapping the table records to business objects and vice versa. In one example, the data access layer 208 may use torque object mapping framework. In one instance, for every table, a data source and DAO object may be defined.

The external system integration layer 210 allows the business layer 206 to interact with the external systems 212 using well-defined interfaces 237 and 250. The transfer server 200 can interact with the DS 250 using the service interface 252. The external system integration layer 210 may provide the abstraction for the service interface APIs 252. The transfer server 200 may interact with the carrier's system 237 for user or device authentication. The external system integration layer 210 can provide access to MDN to subscriber identification (SID) mapping.

The transfer server common services layer 214 contains modules that may be accessed directly by a number of functional entities (e.g., presentation layer 202, business logic interface layer 204, business layer 206, data access layer 208, external system integration layer 210, etc.). The transfer server common services 214 includes a session manager 264, application manager 266, configuration manager 268, plug-in manager 270, exception manager 272, log manager 274, utilities 276, and catalog manager 278.

The session manager 264 has an API SessionID openTransfer( ) that creates new transfer session and with an API closeTransfer(SessionID) that closes the session created by function openTransfer( ). The session manager 264 maintains a session for each transfer and provides an API to save the transferred data into the session.

The configuration manager 268 allows the administrator to set system configuration. The configuration manager 268 further provides classes that may be used by other modules to access the transfer configuration parameter values. The configuration data may be saved as an XML document.

The interface (plug-in) manager 270 is responsible for creating and maintaining external system integration connectors. During the startup of the transfer server 200, the interface manager 270 creates instances of external system connectors. The external interface may be implemented as a set of plug-ins.

The exception manager 272 deals with exception cases of the system, or with the external system. The exception manager 272 operates to rectify runtime by using the default setting, halting the transfer system 22 gracefully, or taking other actions.

The log manager 274 provides an API to create a log file. The API allows other modules to add logging data to the log file. In one instance, only the transfer administrator of business user may view the various logs. The log manager may use the log4j open source package to manage the transfer logs.

The utilities module 276 contains various utilities classes (e.g., string utility, number formatting utilities, XML document utilities, etc.). The utility manager 276 can contain a schedule sub-module that schedules the delivery of the content.

The application manager 266 is responsible for the startup and shutdown of the transfer server 200. The application manager 266 operates to initialize various modules in the business layer 206, and may be responsible for managing single instances in the business logic. In one example, the database may include a transfer table, a user account table (optional), item table, and rule table. The transfer table logs the purchase requests submitted to the service interface 252.

In one aspect, the transfer server 200 can implement HTTPS, HTML, Web Services (SOAP), XML, cascade style sheet, etc. In one example, the MDN to SID mapping is provided by the carrier system 237. The transfer server 200 can define the interface 239. The transfer server 200 communicates with the service interface 252, which in one example, is the BREWZone. In one instance, content transfer from the transfer server 200 to the device 230 occurs after the subscriber has validated device or has performed the MA registration.

The transfer of licensed applications automatically facilitates valuation, negotiation, and billing in order to facilitate the transfer. To that end, the business logic addresses evaluating the existing license rights and offering an appropriate price for transferring equivalent or upgraded license rights for another device. These calculations reflect changes in price that may occur when a different content number is implemented or a new pricing is created. For instance, in a purchase price method (PM), the carrier list price (CLP) and developer application price (DAP) values are zero; hence, the subscriber may not be billed. In the subscription price method, because recurring billing is generated based on DAP and CLP values, the price may be the same as the catalog price. Therefore, in one example, the effective subscription price can be based on the catalog price and a new subscription price will be effective. If the subscription billing (SB) has already been generated for the month, a time adjustment (TA) event may be generated by the transfer server 200 (FIG. 5) to credit for the reinstate Delete (DL) event of the transfer server, if for instance, the content is in the same family. If subscription billing has not been generated for the month, a TA need not be generated. The DE (SE) is on the originating device while the DL (SB) is on the destination device. For limited duration subscription, CLP and DAP values are zero, because deleting a limited duration subscription content may not end the subscription billing. In one example, the subscription may be based on a software identification (SID)/hardware identification (hwID) combination. The destination device may have a different hwID. For a demonstration price technique, according to one example, the remaining licenses will be reinstated irrespective of whether the price basis types match with the original PBT.

In one instance, irrespective of whether price basis types match with the original PBT, remaining licenses will be reinstated. According to one aspect, the local price handle may be used with custom PM/PBT/PBV for Alternate Delivery using BREWZone®. In one example, BREWZone provides the item delivery with custom pricing. BREWZone can further send a TA event to transaction database (TXN) via service value billing (SVB). When the license expires, the user can buy other PBT license types even when PBT does not match for the destination device. In one example, TXN may not include any cross references to any real price handles. Additionally, according to one aspect, no adjustments can be made because the CLP/DAP equals to zero. In one instance, subtype/SVB-State being equal to two will be used for delivery.

Alternatively, in a subscription price technique, unlimited subscription is reinstated on the destination device. If the price has changed, the new subscription price may be used. Because the limited duration subscription has already been paid, limited duration subscription will be reinstated in the same manner as partial license, even if deleted early. In one example, an additional SB is generated with zero CLP/DAP. According to one example, sub-type/SVB State equivalent to two (2) or three (3) may be used. In one instance, delivery of content maybe through alternate purchase using BREWZone.

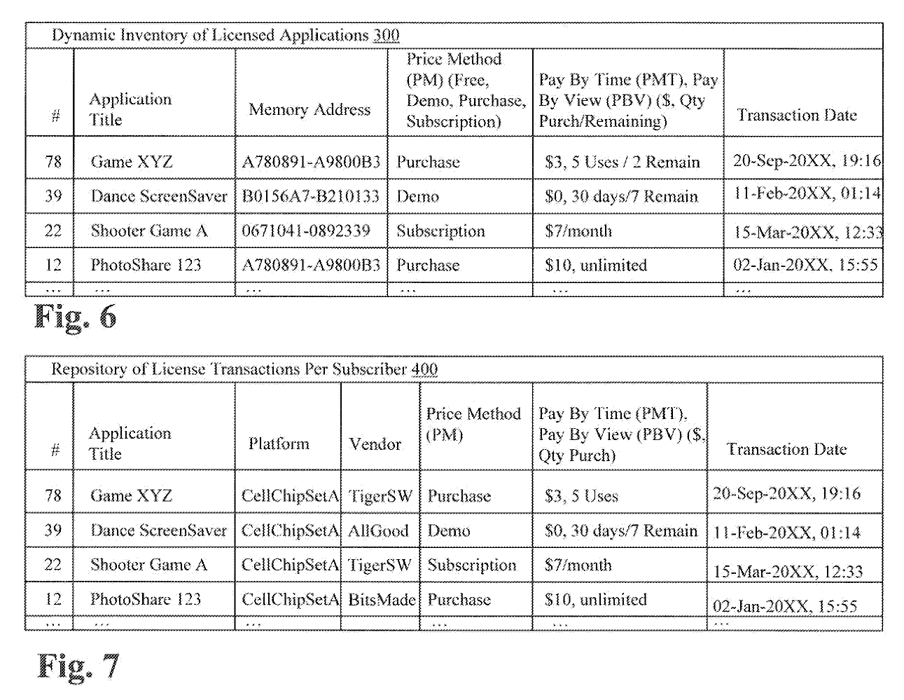

in support of such business log, in FIG. 6, an illustrative device data structure 300 utilized by the device transfer client 160 of FIG. 4 performs the dynamic inventory of licensed applications. Each record corresponds to an application currently installed and licensed, or deleted, on the communication device 104 (FIG. 4). Each licensed application is referred to by a catalog index reference in column “#”, by application title in a column so titled, by a physical memory address, by the type of license (e.g., free, demo, purchase, subscription), by a method of payment (e.g., price per use, price by time, purchase for unlimited duration, etc. A transaction date is provided for cross referencing to network data and for calculating time remaining on duration limited licenses.

In FIG. 7, an illustrative network data structure 400 contains information for validating the licenses of applications inventoried on a device, for recovering an application that was deleted on the device with license duration remaining, and/or to locate an equivalent or upgrade version of the application suitable for transferring to a destination device. To that end, the illustrative data structure 400 pertains to one user ID, or one device ID, with transactions listed by a catalog index for the application, the title of the application, a platform type (e.g., software type and/or hardware type) of the application, a vendor identification for accessing particular billing and price arrangements that may be external to the data structure 400, a price method for the original transaction, a payment arrangement that can be used to determine time or uses remaining on the license, and a transaction date for correlating to the device data structure 300 and for calculating remaining value in the license.

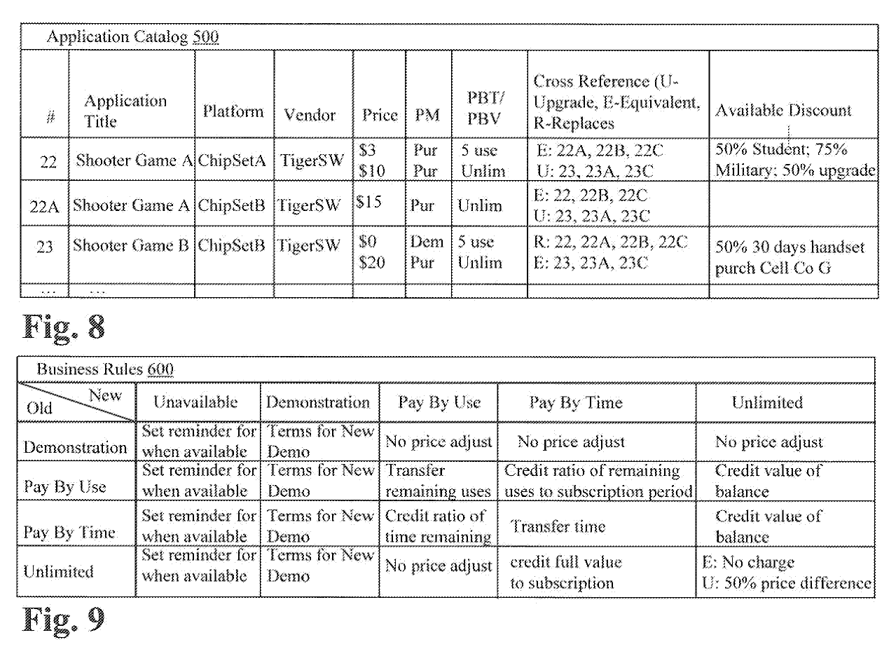

In FIG. 8, an illustrative catalog data structure 500 utilized by the transfer manager provides a cross reference between the catalog reference numbers for the applications in order to determine currently offered license terms, including license type and pricing, whether discounts are available for particular classes of users, and whether a particular version of application by platform is deemed an equivalent or an upgrade to an original application licensed to a user. The business logic may indicate that an upgraded version should be offered, or may indicate that an equivalent should be automatically transferred with upgrade version only selected when the only option or when manually selected by the user.

In FIG. 9, a business logic matrix 600 can serve as a way to map current license rights in an original application to a proposed substitute for a proposed destination device. To that end, the type of license for an “old” application (e.g., demonstration, pay by use, pay by time, unlimited duration) can be cross referenced to available license types for the substitute application located on in the catalog data structure 500. Examples of such business logic include setting a cross sell or other type of future reminder to perform a transfer at a later time if an equivalent or upgraded version is not yet available for the destination device under any license terms. For demonstration versions, the business logic may entail always providing an equivalent upgraded price at no charge. The business logic can include crediting a pay by use or pay by time and equivalent amount with a new version, regardless of whether equivalent or an upgrade, but with future subscription extensions at the new subscription price. Discounts may be offered, such a providing upgraded versions at half of the difference in license price over someone who is not upgrading.

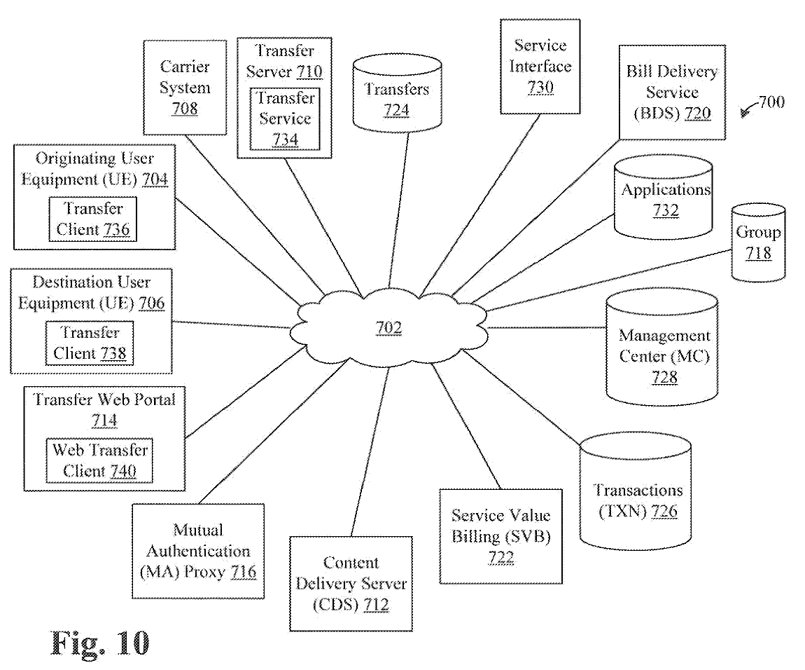

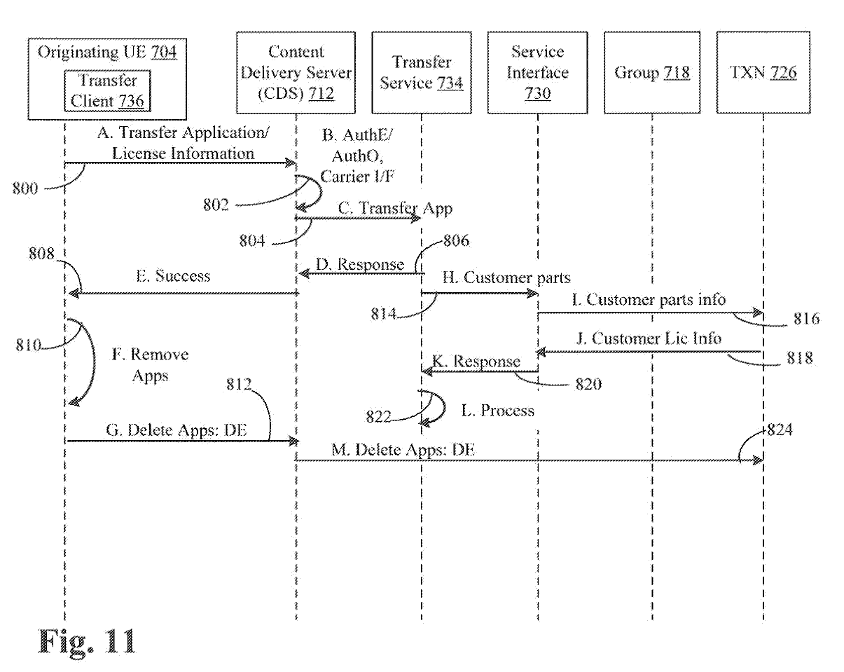

In FIG. 10, a communication system 700 facilitates transfer of content such as a licensed application across a network 702 between originating user equipment (UE) 704 and a destination UE 706. Various computing and networking architectures may be employed with various functional elements as depicted. A carrier system 708 provides communication services to the originating and destination UE 704, 706 for their illustrative purposes as communication devices that happen to execute licensed applications. A transfer server 710 handles backend processing necessary for transfer of licensed application via a distribution channel provided by a content delivery server (CDS) 712. When not authenticating through a device transfer client (not shown) in the originating or destination UE 702 and 704, a transfer web portal 714 can interact with the transfer server 710 to handle user inputs, including authenticating the UE 702 and 704 and the user via a mutual authentication (MA) proxy 716. The UEs 704 and 706 may be part of a group, identified in a group database 718. The carrier system 708 that services the group can be financed by a bill delivery service (BDS) 720 that utilizes data from the service value billing (SVB) 722 to determine subscription rates and billing cycles for the group. The transfer server 710 can track transfers made by records kept in a transfer database 724 with validation of the licenses made prior against a transaction database (TXN) 726. Certain administrative services can be performed through a management center (MC) database 728 that can include authenticating higher level authorizations to view and modify group and user data, etc. Various other external entities, such as carrier systems, can be accessed via a service interface 730. A repository of applications (e.g., executable code) can be retrieved from secure applications database 732.

Architecture arrangements between some or all of these entities of FIG. 10 can be selected based upon the type of communication system 700 and other considerations. In one example, the user may utilize the transfer web portal 714 to communicate to the transfer server 710 so as to initiate content transfer. Alternatively, the user may initiate content transfer using the device user interface provided by the UE 704, 706. Upon receiving the request, the transfer server 710 communicates to the billing entity 720 via the service interface 730. Once the billing and purchase history associated with the content to be transferred have been determined, the billing entity 720 communicates such information to the transfer server 710. The transfer server 710 in turn performs the content mapping followed by the transfer server 710 communicating to the delivery entity 712 invoking a delivery operation for the delivery of the transferred content.

According to another implementation, communication between the transfer server 710 and the user is achieved via the transfer web portal 714 through a web connection. The transfer web portal 714 can be a subscriber device user interface or a subscriber web user interface. The subscriber device user interface may communicate with the application database 732. Similarly, an administrator Web interface (e.g., management center 728) can communicate with the transfer server 710. The transfer server 710 can also access data in the transfer database 724. The transfer server 710 can further communicate to an application database 732 using authenticated content transfer client-to-server communication via the mutual authentication (MA) proxy 716. Communications between the transfer server 710 and the group 718, and the service value billing (SVB) 722 can be achieved via the service interface 730. For instance, the transfer server 710 and the group 718 communicate to facilitate content purchase and delivery. In turn, the group 718 can communicate to the application database 732 so as to access the necessary content (e.g., licensed applications). The transfer server 710 communicates with the SVB 722 for content inventory and billing. The SVB 722 and content delivery server 712 may also communicate with the management center (MC) 728.

In one example with reference to FIG. 4 and FIG. 10, each of the UE 704 and 706 comprises an integrated user interface 164 including the transfer client extension 168 and an application 112. In one example, the integrated user interface 164 is a common user interface for transferring applications 112 and other device content. The transfer client extension 168 is in communication with the transfer service (interchangeably referred to as transfer client that is in-network or hosted and depicted as a transfer service process 734) defined in the delivery system (e.g., CDS 712). In one instance, the transfer client extension 168 provides the IDownload 170 and MA abstraction 172 for the transfer device user interface 164. These components from FIG. 4 are aggregated as depicted at 736 in FIG. 10 on the UE 704 and at 738 on the UE 706. The transfer clients 736, 738 provide device user interfaces for the transfer operation. The transfer client operates with the transfer client extension 168 to handle client to server communications.

According to one aspect, the application 112 is implemented by a developer for a unified application and device content backup/transfer solution. The application 112 of the device 704 is in communication with a device content management service (not shown) that has persistent data storage. In one example, the ABC device content management service can provide device content backup, restore, and transfer for a developer.

Secured communication between the transfer client 160 and the transfer server 710 is facilitated by transfer client 160, the IDownload 170, and IMutualAuth/IWeb 172 on the device side while the content delivery server 712 includes a contentFac (or CI), MA, Web server, and SVC port (not shown). The transfer server 710 includes a transfer service 734 and a service (SVC) port. The device 704 can communicate with the content delivery server 712 as mutual authentication (MA) proxy 716, which in turn communicates to the transfer server 710 and the transfer database 724.

In one aspect, the transfer client 160 may use MA for authenticated communication between the device 704 and the transfer service 734, while the transfer client160 may use HTTP for all non-authenticated communication. The content delivery server (CDS) 712 may be used as a MA proxy 716, which terminates at MA, and passes on remaining data to the transfer service. In one example, an authenticated pipe may be created between the transfer client 160 and the transfer service. MA proxy 716 is the mutual authentication service for the transfer operation. The MA service provides the secured connectivity between the transfer client 160 and the CT server 710. In one example, a carrier (or content provider) interface from the CDS 712 can act as the MA proxy 716 for transfer service.

In another communication system, the UE 704 communicates with the transfer server 710 and the CDS 712. The transfer server 710 is also in contact with the transfer web portal 714, and interfaces with the SVB 722 using the service interface 730. The CDS 712 is in communication with the MC 728 and the group 718.

In another communication system, the UE 704 interfaces with the CDS 712 and the transfer server 710, which in turn, communicates with the MC 728 by way of the service interface 730. The transfer server 710 is also connected to the transfer web portal 714. Alternatively, the UE 704 is in communication with the transfer server 710 and the CDS 712. The MC 728 communicates to the transfer server 710 by way of the service interface 730.

In one example, a hostname of the CDS 712 is automatically inserted by the MA proxy 716 so as to prevent the transfer clients 736 and 738 from having any control over the destination host (not shown). Furthermore, the CDS 712 may be configured so as to provide the necessary authentication/authorization function to the device, and provide device configuration (e.g., when the device has been configured incorrectly).

In FIG. 11, an exemplary call flow from an originating UE 704 to the transfer service 734 of a transfer system 700 is depicted, according to one example. In particular, the originating UE 704 at stage A depicted at 800 sends a request for application/license information to the CDS 712. At stage B depicted at 802, the CDS 712 performs authentication/authorization and forms the carrier interface and sends a transfer application message to the transfer service 734 at stage C depicted at 804. Upon receipt of the information at the transfer service 734, depicted as a stage D response at 806 from the transfer service 734 to the CDS 712 and a stage E success message at 808 to the originating UE 704, the transfer client 736 removes all the applications at stage F depicted at 810 and sends a delete acknowledgement to CDS 712 at stage G depicted at 812. The transfer service 734 queries the TXN 726 at stage H depicted at 814 (via the service interface 730 at stage I depicted at 816) for the customer parts information and ensures that the information sent by transfer client is not tainted. The TXN 726 sends back the customer license information at stage J depicted at 818 to the service interface 730, which in turn relays the response at stage K depicted at 820 to the transfer service 734. The transfer service 734 stores the license information for the SID at stage L, depicted as processing depicted at 822. By about this time, the CDS 712 relays at stage M the deletion of applications to the TXN 726 for storing.

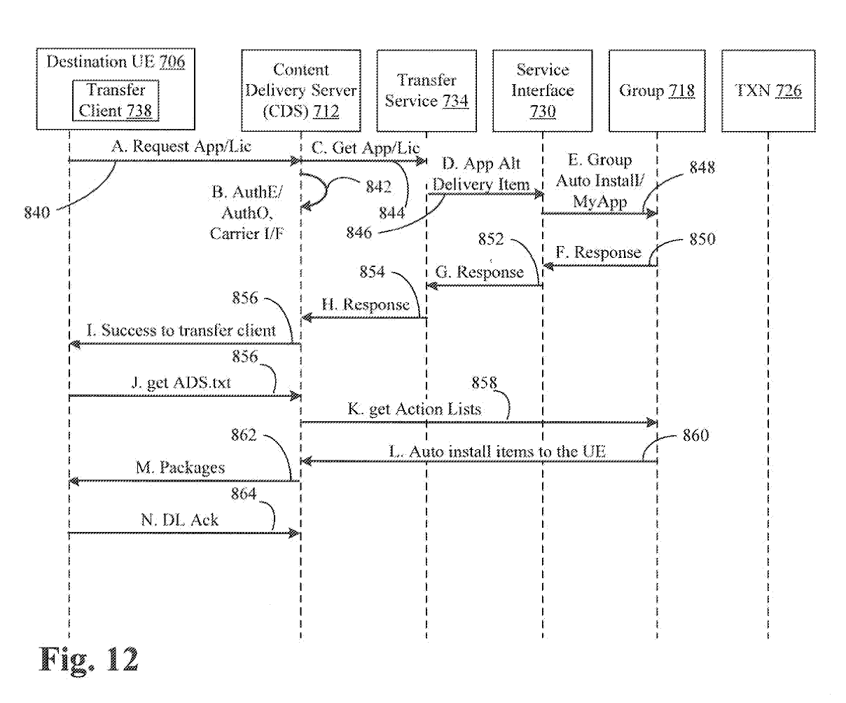

FIG. 12 illustrates an exemplary call flow diagram from the transfer service 734 to the destination UE 706 in a communication system 700 wherein the destination UE 706 includes a transfer client 738, according to one example. At the time that this sequence commences, the originating UE 704 has sent the content/license information to the transfer service 734 and the originating UE 704 has been deactivated. In FIG. 12, the destination UE 706 sends a request for reinstatement to the transfer service 734 and the transfer service 734 obtains the new PID for the SID and determines the applications that can be reinstated to the destination PID. In particular, at stage A depicted at 840, the destination UE 706 sends a request for reinstatement (“request applications/license”) to the CDS 712, which in response performs authentication and authorization and carrier interface at stage B depicted at 842. The CDS 712 relays a get application/license message to the transfer service 734 at stage C depicted at 844. The transfer service 734 obtains the new platform identification (PID) for the subscriber identification (SID) and determines the applications that can be reinstated to the destination PID. Based on the applications, the remaining licenses are reinstated using the interface service 730 and the group 718. In particular, at stage D depicted at 846, an application alternate delivery item message goes from the transfer service 734 to the service interface 730, which in turn at stage G relays a group auto install MyApp message depicted at 848 to the group 718. At stage F, the group 18 provides a response depicted at 850 to the service interface 730, which in turn relays a response message at stage G depicted at 852 to the transfer service 734. The applications are auto-installed along with remaining licenses from the original device. In particular, the transfer service 734 at stage H depicted at 854 relays the response to the CDS 712, which in turn reports at stage I success to transfer client 738 of the destination UE 706. The destination UE 706 responds with a request “get ADS.txt” at stage J, depicted at 856, to the CDS server 712. The CDS 712 sends a request to get the action list at stage K depicted at 858 to the group 718. The group 718 at stage L sends the auto install items depicted at 860 to the CDS 712, which in turn forward the packages at stage M depicted at 862 to the destination UE 706. At stage N depicted at 864, the destination UE 706 returns a download (DL) acknowledgement to the CDS 712.

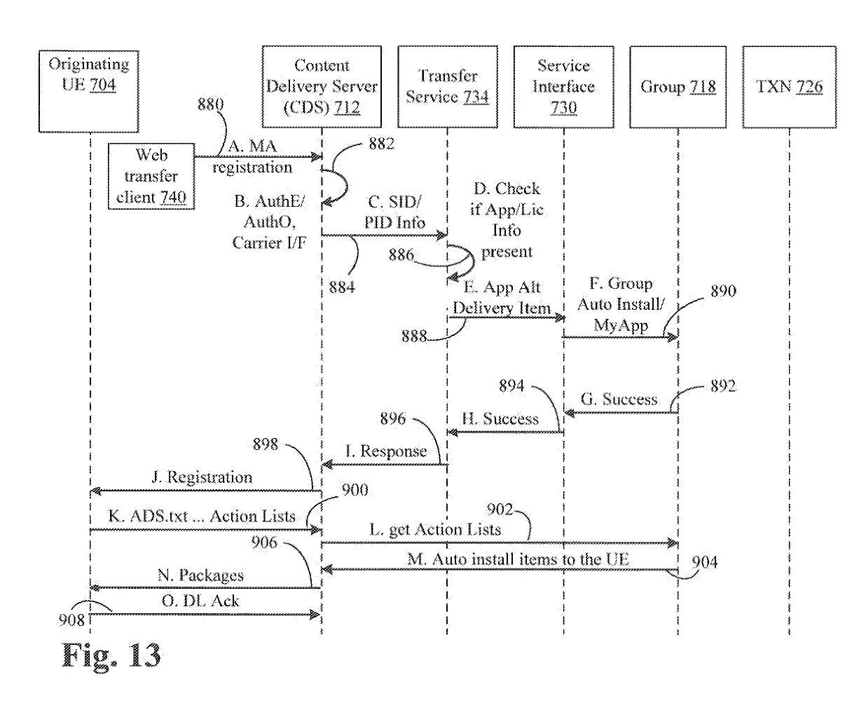

FIG. 13, on the other hand, illustrates an exemplary call flow diagram from the transfer service 734 to the destination UE 706 in a communication system 700 wherein the destination UE 706 does not include a transfer client 738. Thus, in one example, the transfer service 734 provides the content/license information transfer from the transfer web portal 714 using the transfer web client 740 (FIG. 10) instead of from the destination UE 706. Alternatively, this transfer may be a continuation from the transfer process begun by the originating UE 704 where the transfer client 736 may implement the MA and the CDS interfaces to authenticate and authorize the transfer, according to one aspect. In one example, the transfer to the server request includes the transfer web client 740 sending the CT=Ack to the transfer service 734 using logic. The transfer client 736 removes the applications and sends the delete event to the CDS 712. In accordance with one aspect, in a reinstate to device request, reinstatable items/licenses may be available via Group auto actions or Myapps on the device, depending on the device. CT service may implement a CreditBack engine to generate the TA, if necessary. According to one example, the CT service queries the Customer parts and the license information for the SID to generate the true transfer list. If the CT client sends more items that are present in the customer parts, the additional items may be ignored.

In particular, at stage A depicted at 880, the destination UE 706 sends an MA registration message to the CDS 712. At stage B depicted at 882, the CDS 712 performs authentication, authorization and carrier interface. At stage C depicted at 884, the CDS 712 requests the SID/PID information from the transfer service 734, which in turn does a check if the application/license information is present at stage D depicted at 886. Then at stage E depicted at 888, a request for application alternate delivery item is made to the service interface 730, which in turn relays a group auto install/My App request at stage F depicted at 890 to the group 718. The group 718 relays at stage G a success message depicted at 892 to the service interface 730, which in turn at stage H relays a success message depicted at 894 to the transfer service 734. At stage I, the transfer service 734 sends a response message depicted at 896 to the CDS 712, which in turn sends at stage J a registration message to the destination UE 706 depicted at 898. The destination UE 706 replies with ADS.txt and action lists at stage K depicted at 900 to the CDS 712, which in turn sends at stage L a get Action lists request depicted at 902 to the group 718. The group 718 at stage M depicted at 904 sends auto install items to the CDS 712, which at stage N depicted at 906 relays the packages to the destination UE 706, which in turn at stage O depicted 908 sends a download (DL) acknowledgement back to the CDS 712.

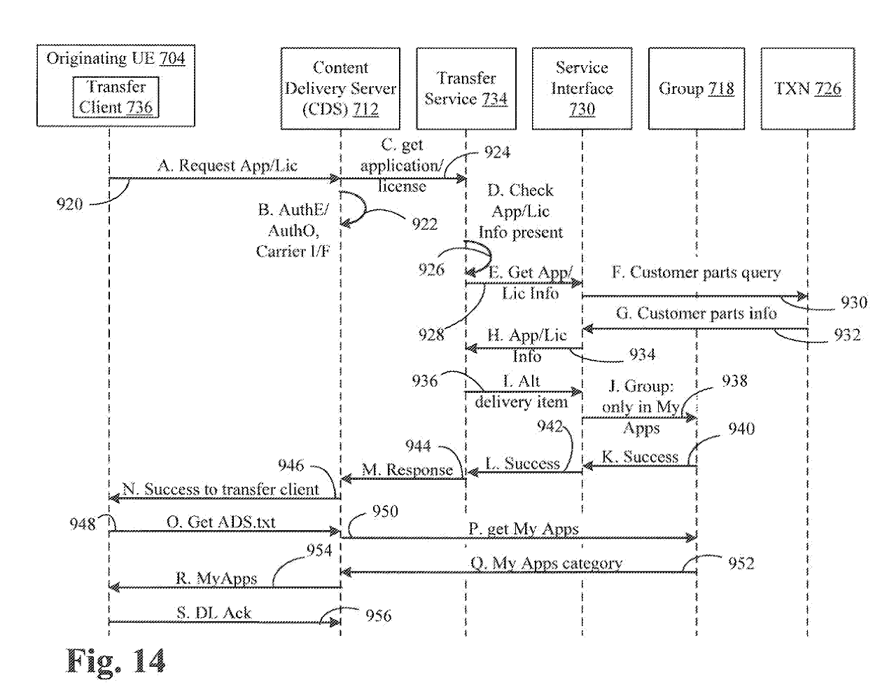

FIG. 14 depicts an exemplary call flow diagram from the transfer service 734 to the destination UE 706 in a communication system 700 wherein no content/license information is available and the destination UE 706 includes a transfer client 738, according to one example. For instance, if the originating UE 704 is lost or damaged, the content/license information cannot be sent to the transfer service 734. Thus, at stage A depicted at 920, the destination UE 706 sends request for application/license message to the CDS 712. The CDS 712 at stage B depicted at 922 authenticates and authorizes the communication and sets up the carrier interface, and then at stage C depicted at 924 requests get the application license from the transfer service 734. The transfer service 734 at stage D depicted at 926 checks to see if the application/license information is present. At stage E depicted at 928, the transfer service 734 sends a get application/license information request to the service interface 730 upon determining that the original UE 704 has not sent such information already. At stage F depicted at 930, the service interface 730 relays the request for customer parts query to the TXN 930, which responds at stage G with the customer parts information depicted at 932. The service interface 730 relays the application/license information to the transfer service at stage H depicted at 934. Based upon business rules, the transfer service at stage I requests alternate delivery item depicted at 936 from service interface 730, which in turn relays the request in stage J depicted at 938 to the group 718. The group 718 at stage K responds with a success response depicted at 940 to the service interface 730, which in turn at stage L responds with a success response depicted at 942 to the transfer service 734. At stage M, the transfer service sends a response message depicted at 944 to the CDS 712, which in turn returns a success message to the transfer client 738. In stage O, the destination UE 706 responds with a get ADS.txt message to the CDS 712, which in stage P depicted at 950 sends a get My Apps request to the group 718. In stage Q, the group 718 responds with the My Apps category depicted at 952 to the CDS 712, which sends the My Apps in stage R to the destination UE 706, depicted at 954. Then in stage S, the destination UE 706 acknowledges the download, depicted at 956.

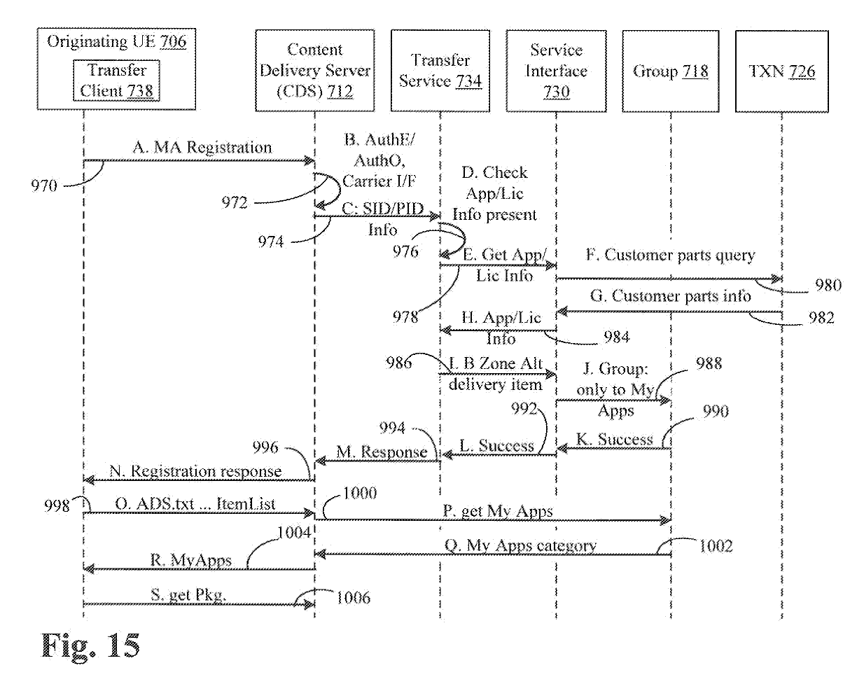

FIG. 15 depicts an exemplary call flow diagram from the transfer service 734 to the destination UE 706 in a communication system 700 wherein no content/license information is available and the destination UE 706 does not include a transfer client 738, according to one example. In the illustrated example, because the destination UE 706 does not include a transfer client 738, the CDS 712 may implement the carrier interface (CI) to communicate to the transfer service 734 once the new destination UE 706 has registered. In particular, at stage A depicted at 970, the destination UE 706 sends an MA registration to the CDS 712. The CDS 712 at stage B performs authentication, authorization and creates the carrier interface, depicted at 972. At stage C, the CDS 712 requests the SID/PID information from the transfer server 734, depicted at 974. At stage D, the transfer server 734 checks for the presence of the application/license information, depicted at 976. At stage E, the transfer server 734 sends a request to get application/license information depicted at 978 from the service interface 730. At stage F, the service interface 730 relays a request for customer parts query to the TXN 726, depicted at 980. At stage G, the TXN 726 responds with the customer parts information, depicted at 982, to the service interface 730. At stage H, the service interface 730, the application/license information is relayed to the transfer service 734, depicted at 984. At stage I, the transfer service 734 sends to the service interface 734 sends a BREWZone alternate delivery item request, depicted at 986, to the service interface 730. At stage J, the service interface 730 sends a “group: only to My Apps” message to the group 718, depicted at 988. The group 718 responds with a success message at stage K depicted at 990. The service interface 730 relays the success message at stage L depicted at 992 to the transfer service 734. At stage M, the transfer service 734 sends a response message depicted at 994 to the CDS 712. At stage N, the CDS 712 sends a registration response to the destination UE 706. At stage O, the destination UE 706 sends an ADS.txt . . . ItemList message to the CDS 712, depicted at 998. The CDS 712 sends a “get My Apps” message to the group 718, depicted at 1000. At stage Q, the group 718 sends My Apps category depicted at 1002 to the CDS 712, which in turn sends at stage R My Apps depicted at 1004 to the destination UE 706, which in turn at stage S responds with a “get Pkg” message depicted at 1006 to the CDS 712.

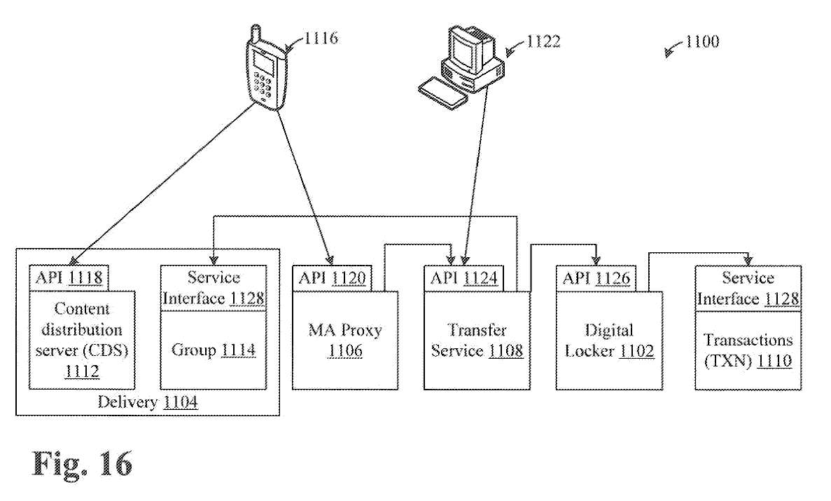

FIG. 16 is a schematic diagram of an exemplary architecture for a communication system 1100 for implementing a digital locker 1102, according to one aspect. The system 1100 includes a delivery system 1104, MA proxy 1106, transfer service 1108, digital locker 1102, and TXN 1110. The delivery system 1104 includes a content distribution server (CDS) 1112 and Group 1114. A UE 1116 interfaces with the CDS 1112 and the MA proxy 1106 via respective APIs 1118, 1120. An administrator web system 1122 can interact with the transfer service 1108 via the transfer service API 1124. The MA proxy 1106 interfaces with the transfer service 11 via the transfer service API 1124. The transfer service 1108, in turn, interacts with the digital locker 1102 via a digital locker API 1126. The transfer service 1108 interfaces with the Group 1114 and the TXN 1110 via a service interface 1128. In one aspect, the functions (e.g., APIs) for the transfer digital locker 1102 are Put, Get, Update, and Remove. The UE 1116 uses the Put function to obtain the transfer backup license. The put function passes through the MA proxy 1106, the transfer service 1108 to the digital locker 1102, which is associated with the TXN 1110. The functions Get and Update can be used by the Web system 1122, and the functions Get, Update, and Remove can be used by the 1116 to reinstate applications in the transfer system 1100.

According to one example, the digital locker includes subscriber information (SID), content (e.g., licenses), and metainfo (e.g., information associated with the owner of the content). The Subscriber information may be SID or PID. The content (e.g., licenses) can be represented in an XML object form with a predefined dtd. Metainfo is information associated with the owner of the content which allows the owner specific logic to be used for the content. In one example, the logic can be either a digital locker function or the owner function (e.g., content expiry, status of the content, etc.). For instance, in one example, the content owner can be CT, TXN, consumer portal, etc.

The various illustrative logics, logical blocks, modules, and circuits described in connection with the versions disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects and/or implementations, it should be noted that various changes and modifications could be made herein without departing from the scope of the described aspects and/or implementations as defined by the appended claims. Furthermore, although elements of the described aspects and/or implementations may be described or claimed in the singular, the plural is contemplated unless limitation to the singular is explicitly stated. Additionally, all or a portion of any aspect and/or implementations may be utilized with all or a portion of any other aspect and/or implementation, unless stated otherwise.

What is claimed is:

1. A method for transacting and transferring a computer-implemented application related to a currently licensed application, comprising:
determining license rights held by a user for an original application executed by a first user device having a first configuration suitable to execute the application;
mapping the original application to a substitute application suitable for execution on a second user device having a second configuration;
applying a pricing business rule to price a transaction for licensing the user to use the substitute application in lieu of using the original application; and
concluding the transaction by provisioning the second user device with the substitute application.

2. The method of claim 1, further comprising commanding deletion of the original application from the first user device.

3. The method of claim 1, further comprising signaling the first user device to lock the original application from being used.

4. The method of claim 1, further comprising:
requesting an inventory of the original application on the first user device; and
validating the license rights for the original application by referencing a transaction database.

5. The method of claim 1, wherein the license rights comprise a use limitation, pricing the transaction comprises determining a remaining portion of use allowed by the license rights and applying a value of the remaining portion against an upgrade price.

6. The method of claim 5, further comprising requesting a tracking from the first user device of a number of times that the original application has executed to determine the remaining portion.

7. The method of claim 5, further comprising requesting a tracking from the first user device of an amount of time that the original application has executed to determine the remaining portion.

8. The method of claim 1, further comprising provisioning the second user device by wirelessly communicating the substitute application to the second user device.

9. The method of claim 1, further comprising provisioning the second user device by signaling to unlock the substitute application residing on the second user device.

10. The method of claim 1, wherein the provisioning of the second user device is deferred, the method further comprising determining a credit back for a remaining portion of the license rights.

11. The method of claim 1, further comprising interacting with the user by signaling to a user interface of the first user device to negotiate the transaction.

12. The method of claim 1, further comprising interacting with the user by signaling to a user interface of the second user device to negotiate the transaction.

13. The method of claim 1, further comprising interacting with the user by signaling a user interface of a networked computer to negotiate the transaction.

14. The method of claim 1, wherein the application comprises an executable code.

15. The method of claim 1, further comprising performing a billing transaction to reflect the transaction price.

16. The method of claim 1, further comprising recording a substitute license rights transactions to reflect the provisioning of the substitute application to the second user device.

17. The method of claim 1, further comprising:
in response to availability of an equivalent application having a benefit over the original application, determining a population of user devices with license rights to the original application;
distributing the equivalent application to the population of user devices; and
signaling to deactivate the original application.

18. At least one processor configured to transact and transfer a computer-implemented application related to a currently licensed application, comprising:
a first module for determining license rights held by a user for an original application executed by a first user device having a first configuration suitable to execute the application;
a second module for mapping the original application to a substitute application suitable for execution on a second user device having a second configuration;
a third module for applying a business rule to price a transaction for licensing the user to use the substitute application in lieu of using the original application; and
a fourth module for concluding the transaction by provisioning the second user device with the substitute application.

19. A computer program product, comprising:
a computer-readable medium comprising:
at least one instruction for causing a computer to determine license rights held by a user for an original application executed by a first user device having a first configuration suitable to execute the application;
at least one instruction for causing the computer to map the application to a substitute application suitable for execution on a second user device having a second configuration;
at least one instruction for causing the computer to apply a business rule to price a transaction for licensing the user to use the substitute application in lieu of using the original application; and
at least one instruction for causing the computer to conclude the transaction by provisioning the second user device with the substitute application.

20. An apparatus, comprising:
means for determining license rights held by a user for an original application executed by a first user device having a first configuration suitable to execute the application;
means for mapping the original application to a substitute application suitable for execution on a second user device having a second configuration;
means for applying a business rule to price a transaction for licensing the user to use the substitute application in lieu of using the original application; and
means for concluding the transaction by provisioning the second user device with the substitute application.

21. An apparatus for transacting and transferring a computer-implemented application related to a currently licensed application, comprising:
a transfer management component for determining license rights held by a user for an original application executed by a first user device having a first configuration suitable to execute the application;
an application catalog for mapping the original application to a substitute application suitable for execution on a second user device having a second configuration;
a rule engine for applying a business rule to price a transaction for licensing the user to use the substitute application in lieu of using the original application; and
a distribution component for concluding the transaction by provisioning the second user device with the substitute application.

22. The apparatus of claim 21, further comprising a billing entity in communication with the transfer management component to perform a billing transaction reflecting the price of the concluded transaction.

23. The apparatus of claim 21, further comprising an application reconciling component that compares an application inventory of the first user device against a transaction record stored remote to the first user device.

24. The apparatus of claim 21, wherein the distribution component further comprises an auto-delete function to cause the deletion of the original application on the first user device.

25. The apparatus of claim 21, wherein the first and second user devices comprise a portable communication device, the apparatus further comprising a service interface to a carrier service for at least one of the first and second user device.

26. A method for transacting and transferring a computer-implemented application related to a currently licensed application, comprising:
requesting a determination of license rights held by a user for an original application executed by a first user device having a first configuration suitable to execute the application;
accepting a mapping of the original application to a substitute application suitable for execution on a second user device having a second configuration;
accepting a transaction price which was determined by applying a business rule to price a transaction for licensing the user to use the substitute application in lieu of using the original application; and
concluding the transaction by receiving provisioning of the second user device with the substitute application.

27. The method of claim 26, further comprising deleting the original application from the first user device in conjunction with concluding the transaction.

28. The method of claim 26, further comprising locking the original application from being used in conjunction with concluding the transaction.

29. The method of claim 26, further comprising:
keeping an inventory of the original application on the first user device; and
sending the inventory for validating the license rights of the original application with reference to a transaction database.

30. The method of claim 26, wherein the license rights comprise a use limitation, keeping an inventory of the original application on the first user device for pricing the transaction comprises determining a remaining portion of use allowed by the license rights so that a value can be applied to the remaining portion against an upgrade price.

31. The method of claim 30, further comprising tracking a number of times that the original application has executed to determine the remaining portion.

32. The method of claim 30, further comprising tracking an amount of time that the original application has executed to determine the remaining portion.

33. The method of claim 26, further comprising provisioning the second user device by wirelessly receiving a communication of the substitute application to the second user device.

34. The method of claim 26, further comprising provisioning the second user device by unlocking the substitute application residing on the second user device.

35. The method of claim 26, further comprising deferring provisioning of the second user device is deferred to receive a credit back for a remaining portion of the license rights.

36. The method of claim 26, further comprising interacting with the user via a user interface of the first user device to negotiate the transaction.

37. The method of claim 26, further comprising interacting with the user by via a user interface of the second user device to negotiate the transaction.

38. The method of claim 26, further comprising interacting with the user via user interface of a networked computer to negotiate the transaction.

39. The method of claim 26, wherein the application comprises an executable code.

40. The method of claim 26, further comprising accepting a substitute application that causes a billing transaction to reflect the transaction price.

41. The method of claim 26, further comprising updating inventory tracking to reflect the substitute application on the second user device.

42. The method of claim 26, further comprising:
receiving provisioning of an equivalent application that replaces the original application sent in response to availability of an equivalent application having a benefit over the original application; and
deactivating the original application.

43. At least one processor configured to transact and transfer a computer-implemented application related to a currently licensed application, comprising:
a first module for requesting a determination of license rights held by a user for an original application executed by a first user device having a first configuration suitable to execute the application;
a second module for accepting a mapping of the original application to a substitute application suitable for execution on a second user device having a second configuration;
a third module for accepting a transaction price which was determined by applying a business rule to price a transaction for licensing the user to use the substitute application in lieu of using the original application; and
a fourth module for concluding the transaction by receiving provisioning of the second user device with the substitute application.

44. A computer program product, comprising:
a computer-readable medium comprising:
at least one instruction for causing a computer to request a determination of license rights held by a user for an original application executed by a first user device having a first configuration suitable to execute the application;
at least one instruction for causing the computer to accept a mapping of the original application to a substitute application suitable for execution on a second user device having a second configuration;
at least one instruction for causing the computer to accept a transaction price which was determined by applying a business rule to price a transaction for licensing the user to use the substitute application in lieu of using the original application; and
at least one instruction for causing the computer to conclude the transaction by receiving provisioning of the second user device with the substitute application.

45. An apparatus, comprising:
a means for requesting a determination of license rights held by a user for an original application executed by a first user device having a first configuration suitable to execute the application;
a means for accepting a mapping of the original application to a substitute application suitable for execution on a second user device having a second configuration;
a means for accepting a transaction price which was determined by applying a business rule to price a transaction for licensing the user to use the substitute application in lieu of using the original application; and
a means for concluding the transaction by receiving provisioning of the second user device with the substitute application.

46. An apparatus for transacting and transferring a computer-implemented application related to a currently licensed application, comprising:
a communication component for requesting a determination of license rights held by a user for an original application executed by a first user device having a first configuration suitable to execute the application; and
a user interface for accepting a mapping of the original application to a substitute application suitable for execution on a second user device having a second configuration and for accepting a transaction price which was determined by applying a business rule to price a transaction for licensing the user to use the substitute application in lieu of using the original application,
wherein the communication component concludes the transaction by receiving provisioning of the second user device with the substitute application.

47. The apparatus of claim 46, further comprising an application inventory component that tracks the original application for reconciling against a transaction record stored remote to the first user device.

48. The apparatus of claim 46, further comprising a transfer client operable to delete the original application on the first user device in conjunction with concluding the transaction.

49. The apparatus of claim 46, wherein a selected one of the first and second user devices comprises a portable communication device in communication with a carrier service.
